(19) United States
(12) Patent Application Publication
(10) Pub. No.: US 2013/0295328 A1
(43) Pub. Date: Nov. 7, 2013

(54) TRANSFER ARTICLE HAVING MULTI-SIZED PARTICLES AND METHODS

(71) Applicants: Jimmie R. Baran, JR., Prescott, WI (US); Paul S. Lugg, Woodbury, MN (US); Terry L. Smith, Roseville, MN (US); Terrance P. Smith, Woodbury, MN (US)

(72) Inventors: Jimmie R. Baran, JR., Prescott, WI (US); Paul S. Lugg, Woodbury, MN (US); Terry L. Smith, Roseville, MN (US); Terrance P. Smith, Woodbury, MN (US)

(73) Assignee: 3M INNOVATIVE PROPERTIES COMPANY, St. Paul, MN (US)

(21) Appl. No.: 13/885,496

(22) PCT Filed: Dec. 9, 2011
(86) PCT No.: PCT/US11/64079

§ 371 Date: May 15, 2013

Related U.S. Application Data
(60) Provisional application No. 61/424,457, filed on Dec. 17, 2010.

(51) Int. Cl. B41M 5/00

(52) U.S. Cl. CPC B41M 5/00
USPC 428/142; 428/143; 428/148; 428/149

(57) ABSTRACT

A transfer article that includes a liner with multi-sized particles disposed thereon, wherein the multi-sized particles include a plurality of dominant hydrophilic particles having an average primary particle size of no greater than 200 microns, and a plurality of discrete hydrophobic nanoparticles.

### CROSS REFERENCE TO RELATED APPLICATION

This application claims the benefit of U.S. Provisional Patent Application No. 61/424,457, filed Dec. 17, 2010, the disclosure of which is incorporated by reference herein in its entirety.

### BACKGROUND

There is a desire to produce articles for packaging, protection, and storage of particles in a film format and for eventual delivery of a monolayer of these particles onto a substrate. In such transfer articles, an electrostatic force that is present in a release liner, whether such liner is based on paper, polymeric films including non-woven films, or fabrics, can be used to temporarily bond the particles to the liner. The electrostatic attraction between the transfer liner and the particles, however, is not so strong that the particles will not release from the liner. Such electrostatic force is not created by the use of an external source of energy to impart an electric charge to the particles.

Such transfer articles having a loosely attached electrostatic coating of particles on a release liner, are particularly suited for applying a monolayer coating of particles onto a tacky surface of a receiving layer and delivering particles where the release surface is unperturbed or uncontaminated by the tacky receiving layer. Such transfer articles are particularly desirable for use in forming abrasive articles and optical devices.

This mechanism of adhesion (“static cling”) of particles to a release liner is not effective for all particles in all environments. One difficulty with electrostatic coatings is that they can be susceptible to atmospheric humidity. Moisture adsorbed onto the release liner or the particles can dissipate static charge, thereby rendering the coating less complete and more fragile. For example, certain smooth surface release liners are more susceptible to humidity interfering with the static cling of particles. This is due to the lower surface-to-surface contact between the liner and the particles, thus requiring greater electrostatic charge to achieve the attachment. Kraft paper liners coated with silicone can have greater surface topology and therefore multiple contact spots between the liner surface and the particle surface and hence better cling in humid conditions.

Although metal particles and hydrophobic particles typically adhere well using electrostatic forces, some hydrophilic particles are susceptible to adsorbing surface moisture, which dissipates static charge, thereby providing poor quality coatings.

It has been discovered that the problem of using electrostatic force to adhere hydrophilic particles to a release liner can be overcome by combining the hydrophilic particles with much smaller hydrophobic particles. Such combination of particles is particularly useful for suppressing the effects of humidity, and enabling an electrostatic coating of hydrophilic particles onto a release liner, whether such liner is based on paper, polymeric films including non-woven films, or fabrics, to temporarily bond the particles to the liner. Such combination of particles is particularly useful for suppressing the effects of humidity, and enabling an electrostatic coating of hydrophilic particles onto a smooth glossy-finish (as opposed to a matte-finish) release liner. Such combination of particles includes a plurality of dominant hydrophilic particles having an average primary particle size of no greater than 200 microns, and a plurality of discrete hydrophobic nanoparticles.

In one embodiment, the present disclosure provides a transfer article that includes:

a first flexible liner having opposing first and second surfaces, wherein the first surface has a release value of less than 700 grams per inch per ASTM D3330/D3330M-04; multi-sized particles adhered to the first surface of the first flexible liner; wherein the particles include:
a plurality of dominant hydrophilic particles having an average primary particle size of no greater than 200 microns; and a plurality of discrete hydrophobic nanoparticles; wherein the dominant particles are disposed in a monolayer; and a second flexible liner having opposing first and second surfaces, wherein the second liner is in physical contact with at least a portion of the multi-sized particles.

In one aspect of this embodiment of a transfer article, the first flexible liner and the second flexible liner are portions of the same flexible liner, and the transfer article is in the form of a roll. In another aspect of this embodiment of a transfer article, the first flexible liner is a distinct liner from the second flexible liner, and the first surface of the second flexible liner has a release value of less than 700 grams per inch as measured according to ASTM D3330/D3330M-04, and wherein the second flexible liner is disposed on the layer of particles such that the first surface of the second flexible liner is in contact with the particles.

In another embodiment, the present disclosure provides a transfer article that includes: a first liner (which may or may not be flexible) having opposing first and second surfaces, wherein the first surface has a release value of less than 700 grams per inch per ASTM D3330/D3330M-04; multi-sized particles adhered to the first surface of the first liner by electrostatic forces without a binder; wherein the particles include: a plurality of dominant hydrophilic particles having an average primary particle size of no greater than 200 microns; and a plurality of discrete hydrophobic nanoparticles; wherein the dominant particles are preferably disposed in a monolayer.

The present disclosure also provides methods of using transfer articles of the present disclosure, i.e., methods of transferring particles to a substrate.

In one embodiment, the present disclosure provides a method of transferring particles to a substrate, wherein the method includes: providing a substrate having opposing first and second surfaces; [symbol] positioning the first liner on the binder coated on the first surface of the substrate such that the multi-sized particles are in contact with the binder; removing the first liner from the substrate in a manner that separates at least a portion of the multi-sized particles from the first liner thereby transferring multi-sized particles to the substrate; and curing the binder thereby securing the transferred multi-sized particles to the first surface of the substrate.

In another embodiment, the present disclosure provides a method of transferring particles to a substrate, wherein the method includes: providing a substrate having opposing first and second surfaces; coating a binder on the first surface of the substrate; providing a transfer article in roll form as described herein; unrolling the transfer article to expose the multi-sized particles disposed on the flexible liner; positioning the flexible liner on the binder coated on the first surface of the substrate such that the multi-sized particles are in contact with the binder; removing the flexible liner from the substrate in a manner that separates at least a portion of the multi-sized particles from the flexible liner thereby transferring multi-sized particles to the substrate; and curing the binder thereby securing the transferred multi-sized particles to the first surface of the substrate.

In another embodiment, the present disclosure provides a method of transferring particles to a substrate, wherein the method includes: providing a substrate having opposing first and second surfaces; coating a binder on the first surface of the substrate; providing a transfer article as described herein; removing the second flexible liner from the transfer article to expose the multi-sized particles disposed on the first flexible liner; positioning the first flexible liner on the binder coated on the first surface of the substrate such that the multi-sized particles are in contact with the binder; removing the first flexible liner from the substrate in a manner that separates at least a portion of the multi-sized particles from the first flexible liner thereby transferring multi-sized particles to the substrate; and curing the binder thereby securing the transferred multi-sized particles to the first surface of the substrate.

As used herein, in the context of particles and the materials of which they are made, the term “hydrophilic” means having a contact angle≦90° with water (preferentially wetted by water). This hydrophilic material can be inorganic, organic, or a combination thereof.

As used herein, in the context of particles and the materials of which they are made, the term “hydrophobic” means repelling of water, measurable by contact angle greater than 90° with water, as described in Sharfrin, E. et al., The Journal of Physical Chemistry, 64(5): 519-524 (1960). This hydrophobic material can be inorganic, organic, or a combination thereof.

In the context of hydrophobic nanoparticles, the term non-vitrifiable means that the nanoparticles do not have a glass transition temperature (Tg) and are not capable of forming a glassy material.

In the context of particles on a liner, the phrase “adhered to” means the particles are loosely attached to the liner as a result of an electrostatic attraction between the particles and liner but they do not fall off the surface of the liner under the force of gravity when the liner is held in a vertical position. This adhesion is not so strong that the particles will not release from the liner.

[symbol]

hydrophobic nanoparticles, i.e., the dominant particles have an average primary particle size greater than the average primary particle size of the nanoparticles.

The terms “comprises” and variations thereof do not have a limiting meaning where these terms appear in the description and claims.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

As used herein, “a,” “an,” “the,” “at least one,” and “one or more” are used interchangeably.

As used herein, the term “or” is generally employed in its usual sense including “and/or” unless the content clearly dictates otherwise. The term “and/or” means one or all of the listed elements or a combination of any two or more of the listed elements.

All numbers are herein assumed to be modified by the term “about” and preferably with the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. The recitation of numerical ranges by endpoints includes all numbers subsumed within that range (e.g., 1 to 5 includes 1, 1.5, 2, 2.75, 3, 3.80, 4, and 5). All parts recited herein, including those in the Example section below, are by weight unless otherwise indicated.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

The disclosure will be further described with reference to the following drawings, wherein:

FIG. 1 is a schematic cross-sectional view of a transfer article according to one aspect of the present disclosure;

FIG. 2 is a schematic cross-sectional view of an exemplary method of transferring particles from a transfer article according to one aspect of the present disclosure;

FIG. 3 is a perspective view of a roll of transfer article according to one aspect of the present disclosure; hydrophilic particles electrostatically bound onto a liner (left) compared to a transfer article according to one aspect of the present disclosure with dominant hydrophilic particles and discrete hydrophobic nanoparticles (right) having a more uniform and higher density monolayer;

FIG. 5 is a microscope photograph of the transfer article shown in the right panel of FIG. 4 with a blend of the dominant hydrophilic particles and hydrophobic nanoparticles (not of sufficient magnification to be seen) held electrostatically onto a release liner under humid conditions; and

FIG. 6 is a photograph of a transfer article with a blend of the dominant hydrophilic calcium carbonate particles and hydrophobic nanoparticles (not of sufficient magnification to be seen) held electrostatically onto a release liner under humid conditions.

These figures are illustrative, are not drawn to scale, and are intended merely for illustrative purposes.

### DETAILED DESCRIPTION OF ILLUSTRATIVE EMBODIMENTS

A transfer article includes a liner, typically a flexible liner, often referred to as a release liner, and multi-sized particles disposed thereon. Herein, the term “multi-sized particles” refers to a plurality of dominant hydrophilic particles having an average primary particle size of no greater than 200 microns, and a plurality of discrete hydrophobic nanoparticles.

In one embodiment, the present disclosure provides a transfer article that includes a first liner having opposing first and second surfaces, multi-sized particles adhered to the first surface of the first liner by electrostatic forces; the multi-sized particles including a plurality of dominant hydrophilic particles having an average primary particle size of no greater than 200 microns, and a plurality of discrete hydrophobic nanoparticles. Preferably, the dominant particles are disposed in a monolayer.

By combining dominant hydrophilic particles with hydrophobic nanoparticles as described and exemplified herein, the dominant hydrophilic particles form a more uniform and higher density layer (preferably, a monolayer) than the same dominant hydrophilic particles without the hydrophobic nanoparticles. In the latter situation, the dominant hydrophilic particles typically form a discontinuous layer. Similarly, by combining dominant hydrophilic particles with hydrophobic nanoparticles as described and exemplified herein, the dominant hydrophilic particles form a more uniform and higher density layer (preferably, a monolayer) than the same dominant hydrophilic particles blended with hydrophobic particles that are not nanoparticles (i.e., that are larger than 100 nanometers). In the latter situation, the dominant hydrophilic particles and hydrophobic particles larger than 100 nanometers typically form a discontinuous layer. Thus, the hydrophobic nanoparticles enhance the electrostatic attraction of the dominant hydrophilic particles to a release liner to form a more closely packed, higher density layer. This is particularly advantageous under humid conditions, e.g., a relative humidity (RH) of at least 35% or a dewpoint of 67° F. to 40° F. (a room with 70° F. temperature and a 40° F. dew point translates to a RH of 35%).

[symbol]

“without a binder” it is meant that an amount of a binder that is sufficient to cause the particles to adhere is not present. That is, the present disclosure does not use the release coating or any other binders (e.g., by embedding the particles therein) for adhering the particles to the liner. Also, the present disclosure does not use an external source of energy to impart an electric charge to the particles.

In certain embodiments, the dominant particles have an average primary particle size 100 to 10,000 times larger than the average primary particle size of the nanoparticles. With the use of the hydrophobic nanoparticles, the layer of dominant hydrophilic particles is less susceptible to the effects of moisture. Thus, a more uniform and higher density coating of hydrophilic particles on a liner can be created using electrostatic forces than if the hydrophilic particles were used without the hydrophobic nanoparticles. That is, a transfer article according to the present disclosure includes a plurality of hydrophilic particles disposed on a liner in a more uniform and higher density layer than the same hydrophilic particles without the hydrophobic nanoparticles. In certain embodiments, the multi-sized particles are disposed on a liner in a monolayer.

The electrostatic attraction between the transfer liner and this combination of hydrophilic particles and hydrophobic nanoparticles, however, is not so strong that the particles will not release from the liner. The present disclosure does not use an external source of energy to impart an electric charge to the particles. Furthermore, the multi-sized particles of the present disclosure are not embedded in the liner (e.g., a coating thereon) but instead cling to the liner (e.g., the release coating side of the release liner) such that they do not fall off under the force of gravity when the liner is held in a vertical position.

A transfer article may be in the form of a roll (and subsequently converted into sheets and disks) or may be in the form of a sheet or disk. The transfer articles may include multiple layers of release liner. Transfer articles may be used to modify a substrate, both rigid and flexible, with the multi-sized particles.

With reference to the figures, FIG. 1 shows a schematic cross-sectional view of an exemplary dual liner transfer article 10 having a first liner 12, a second liner 14, and a layer (preferably a monolayer) of a plurality of dominant hydrophilic particles 16 and a plurality of discrete hydrophobic nanoparticles 18 disposed or sandwiched between the two liners. Each of the first and second liner has a first surface 12a and 14a respectively and an opposing second surface 12b and 14b respectively. A release coating (not shown) can be disposed on the first surface 12a of the first liner and optionally on the first surface of 14a of the second liner.

Thus, the dual liner transfer article shown in FIG. 1 is one embodiment of a transfer article that includes: a first liner (preferably, a flexible liner) having opposing first and second surfaces; multi-sized particles adhered to the first surface of the first liner, wherein the multi-sized particles include a plurality of dominant hydrophilic particles having an average primary particle size of no greater than 200 microns, and a plurality of discrete hydrophobic nanoparticles; and a second liner (preferably, a flexible liner) having opposing first and second surfaces, wherein the second liner is in physical contact with at least a portion of the multi-sized particles. In this embodiment in which the transfer article is in the form of a (preferably, flexible) liner, and wherein the second liner is disposed on the layer of particles such that the first surface of the second liner is in physical contact with at least a portion of the particles.

Another embodiment of the present disclosure includes multiple layers of release liner and multi-sized particles. For example, a transfer article may comprise a first liner having a first and second surface; a first layer of multi-sized particles adhered to the first surface of the first liner; a second liner, having a first and second surface, disposed on the first layer of multi-sized particles wherein the first surface of the second liner is in contact with the first layer of multi-sized particles; a second layer of multi-sized particles adhered to the second surface of the second liner, and optionally a third liner, having a first and second surface, wherein the first surface of the third liner is in contact with the second layer of multi-sized particles. The number of layers of liners and the number of layers of multi-sized particles can be selected based on the desired end use.

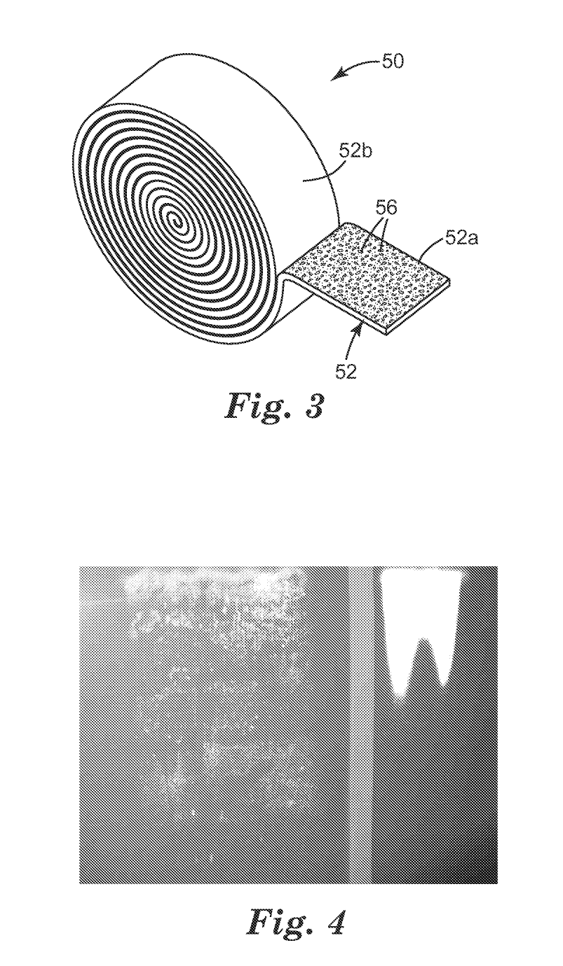

FIG. 3 shows a perspective view a roll of transfer article 50 according to one aspect of the present disclosure, similar to that of a roll of tape. The roll of transfer article 50 includes a single liner 52 having opposing first surface 52a and second surface 52b, with a release coating (not shown) disposed on the first surface 52a. Multi-sized particles 56 are disposed on the first surface 52a. Optionally, a second release coating (not shown) is disposed on the second surface 52b of the liner, the second release coating having a lower release value than the first release coating thereby promoting the unwinding of the roll and reducing if not eliminating the possibility of the multi-sized particles remaining with the second surface 52b of the liner.

Thus, the roll of transfer article shown in FIG. 3 is one embodiment of a transfer article that includes: a first (preferably, flexible) liner having opposing first and second surfaces; multi-sized particles adhered to the first surface of the first liner portion, wherein the multi-sized particles include a plurality of dominant hydrophilic particles having an average primary particle size of no greater than 200 microns, and a plurality of discrete hydrophobic nanoparticles; and a second (preferably, flexible) liner having opposing first and second surfaces, wherein the second liner is in physical contact with at least a portion of the multi-sized particles. In this embodiment in which the transfer article is in the form of a roll, the first (preferably, flexible) liner and the second (preferably, flexible) liner are portions of the same (preferably, flexible) liner. Typically, a transfer article in the form of a roll includes a first release coating disposed on the first surface and a second release coating disposed on the second surface of the flexible liner, wherein the second release coating has a lower release value than the first release coating.

### Materials for the First and Optional Second Liner

The type of liner suitable for use in the present disclosure is not limited, so long as the liner can cause an electrostatic attraction to or electrostatic adhesion between it and the multi-sized particles thereby allowing the multi-sized particles to remain or cling to the liner. The surface of the liner on which the particles are disposed (the “release surface”) has a release value of less than 700 grams per D3330/D3330M-04. In this ASTM D3330/D3330M-04, the release value is determined using the adhesive tape commercially available from 3M Company (Saint Paul, Minn.) under the trade designation 373 3M BOX SEALING TAPE having a width of 2 inches.

The liner may be flexible or rigid. Preferably, it is flexible. A suitable liner (preferably, a flexible liner) is typically at least 0.5 mil thick, and typically no more than 20 mils thick.

In one embodiment, a liner may be a backing with a release coating disposed on its first surface. Optionally, a release coating can be disposed on its second surface. If this backing is used in a transfer article that is in the form of a roll, the second release coating has a lower release value than the first release coating.

Suitable materials that can function as a rigid liner include metals, metal alloys, metal-matrix composites, metalized plastics, inorganic glasses and vitrified organic resins, formed ceramics, and polymer matrix reinforced composites.

Exemplary liner materials include paper and polymeric materials. For example, flexible backings include densified Kraft paper (such as those commercially available from Loparex North America, Willowbrook, Ill.), poly-coated paper such as polyethylene coated Kraft paper, and polymeric film. Suitable polymeric films include polyester, polycarbonate, polypropylene, polyethylene, cellulose, polyamide, polyimide, polysilicone, polytetrafluoroethylene, polyethylenephthalate, polyvinylchloride, polycarbonate, or combinations thereof. Nonwoven or woven liners may also be useful. Embodiments with a nonwoven or woven liner could incorporate a release coating.

In another embodiment, the release coating of the liner may be a fluorine-containing material, a silicon-containing material, a fluoropolymer, a silicone polymer, or a poly(meth)acrylate ester derived from a monomer comprising an alkyl (meth)acrylate having an alkyl group with 12 to 30 carbon atoms. In one embodiment, the alkyl group can be branched. Illustrative examples of useful fluoropolymers and silicone polymers can be found in U.S. Pat. Nos. 4,472,480 (Olson), 4,567,073 (Larson et al.), and 4,614,667 Larson et al.). Illustrative examples of a useful poly(meth)acrylate ester can be found in U.S. Patent Application Publication No. US 2005/118352 (Suwa).

In one embodiment, a first surface of the liner on which the particles are to be disposed may be textured so that at least one plane of the first surface of the liner is higher than another plane. The textured surface may be patterned or random. The highest plane or planes of the textured surface may be designated as the “delivery plane” since the highest plane or planes will deliver the particles to a substrate. The lower plane or planes may be designated as “recessed planes.”

In one embodiment, a first surface of the liner on which the particles are to be disposed may have a smooth, glossy finish (as opposed to a matte finish).

In addition to the dominant particles being hydrophilic and the nanoparticles being hydrophobic, the dominant particles may be distinguished from the nanoparticles by relative particle size (i.e., the longest dimension of a particle, typically the diameter). The dominant particles are larger than the nanoparticles.

The particle size of the nanoparticles used is that which will not interfere in the function of the dominant particles. The larger dominant particles typically have an average primary particle size of at least 50, at least 60, at least 70, at least 80, at least 90, or at least 100 times larger than the average primary particle size of the nanoparticles. In some embodiments, the larger dominant particles have an average primary particle size of at least 200, at least 300, at least 400, at least 500, at least 600, at least 700, or at least 800 times larger than the average primary particle size of the nanoparticles. The larger dominant particles may have an average primary particle size up to 5,000 or 10,000 times larger than the average primary particle size of the nanoparticles.

Nanoparticles can sometimes be aggregated and sometimes agglomerated. “Agglomerate” refers to a weak association between primary particles which may be held together by charge or polarity and can be broken down into smaller entities. “Aggregate” refers to strongly bonded or fused particles where the resulting external surface area may be significantly smaller than the sum of calculated surface areas of the individual components. The forces holding an aggregate together are strong forces, for example, covalent bonds, or those resulting from sintering or complex physical entanglement.

Agglomerated nanoparticles can be broken down into smaller entities such as discrete primary particles, for example, by agitation. The application of a surface treatment to an aggregate simply results in a surface treated aggregate. Unlike fumed silica that comprises large amounts of silica aggregates, the nanoparticles utilized herein comprise a sufficient concentration of discrete unaggregated/unagglomerated nanoparticles. In some embodiments, the nanoparticles are present as discrete unaggregated/unagglomerated nanoparticles. In some embodiments, at least 40%, at least 50%, at least 60%, at least 70%, at least 80%, or at least 90% by weight of the nanoparticles are present as discrete unaggregated/unagglomerated nanoparticles. In the context of nanoparticles, “discrete” means “primary/unaggregated/unagglomerated.”

Typically, the nanoparticles have an average primary (in some embodiments, average primary and agglomerate) particle size (e.g., diameter) of less than 100 nanometers (nm). “Primary particle size” refers to the largest dimension (e.g., the diameter of a spherical particle) of a single (non-aggregated, non-agglomerated) particle. In some embodiments, the nanoparticles have an average primary (in some embodiments, average primary and agglomerate) particle size of no greater than 75 nanometers or no greater than 50 nanometers. The nanoparticles typically have an average primary (in some embodiments, average primary and agglomerate) particle size (e.g., diameter) of at least 3 nanometers. In some preferred embodiments, the average primary (in some embodiments, average primary and agglomerate) based on transmission electron miscroscopy (TEM).

In certain situations, agglomeration as described above for nanoparticles can also occur with the dominant particles. Typically, dominant particles have an average primary (in some embodiments, average primary and agglomerate) particle size (generally measured as an effective diameter) of at least 100 nm (i.e., 0.1 micron), at least 200 nm, at least 300 nm, at least 400 nm, or at least 500 nm. In certain embodiments, the average primary (in some embodiment, average primary and agglomerate) particle size of the dominant particles is no greater than 200 microns, no greater than 150 microns, no greater than 100 microns, no greater than 75 microns, no greater than 50 microns, no greater than 25 microns, no greater than 20 microns, no greater than 15 microns, or no greater than 10 microns.

The dominant particles and nanoparticles are typically substantially spherical in shape. However, other shapes such as elongated shapes may alternatively be employed. Examples of such shapes include rods, triangles, pyramids, cones, solid spheres, hollow spheres and the like. Also, the dominant particles may be randomly shaped. For elongated shapes, an aspect ratio less than or equal to 10 is typical, with aspect ratios less than or equal to 3 more typical.

The amount of nanoparticles used is that amount which will not interfere in the function of the dominant particles. A minor amount (less than 50 weight percent (wt-%) of the multi-sized particle mixture, e.g., 49 wt-% or less) of nanoparticles is generally combined with a major amount (greater than 50 weight percent of the multi-sized particle mixture, e.g., 51 wt-% or more) of dominant particles to form a mixture.

In many embodiments, the hydrophobic nanoparticles will be present in an amount no greater than 10 weight percent solids (i.e., of the total particle mixture of dominant particles and nanoparticles). In some embodiments, the hydrophobic nanoparticles are present in an amount no greater than 5, no greater than 4, no greater than 3, or no greater than 2, weight percent solids. The amount of hydrophobic nanoparticles is typically at least 0.01 wt-%, at least 0.05 wt-%, or at least 0.10 wt-% solids. In some embodiments, the amount of hydrophobic nanoparticles is at least 0.20 wt-% solids, at least 0.30 wt-% solids, at least 0.40 wt-% solids, or at least 0.50 wt-% solids.

In some embodiments, the dominant particles are combined with dry surface-modified nanoparticles. In other embodiments, the dominant particles are combined with a volatile inert liquid that is not a solvent (i.e., with respect to the larger particles), and a nanoparticle-containing colloidal dispersion. Typical liquids that may be employed include, for example, toluene, isopropanol, heptane, hexane, octane, and water. The amount of liquid is sufficiently small such that the liquid evaporates during mixing. The concentration of liquid in the mixture is typically less than 5 wt-%. In some embodiments, the amount of liquid is no greater than 4, no greater than 3, no greater than 2, no greater than 1, or no greater than 0.5 wt-%. If a higher concentration of liquid is employed, the method then typically further comprises removing the liquid, for example by filtering and/or evaporation to recover a free-flowing dry powder.

Although metal particles and hydrophobic particles typically adhere well using electrostatic forces, some hydrophilic particles are susceptible to adsorbing surface moisture, which dissipates static charge, and thereby reduces adhesion. Examples of hydrophilic particles that are susceptible to reduced adhesion under humid conditions are those with a silica and/or titania coating, and calcium carbonate particles. Typical humid conditions that can cause reduced adhesion can be described as including a relative humidity (RH) of at least 35% or a dewpoint of 67° F. to 40° F. (a room with 70° F. temperature and a 40° F. dew point translates to a RH of 35%).

Exemplary dominant hydrophilic particles include fused aluminum oxide, heat treated aluminum oxide, white fused aluminum oxide, black silicon carbide, green silicon carbide, titanium diboride, boron carbide, tungsten carbide, titanium carbide, diamond (both natural and synthetic), silica, iron oxide, chromia, ceria, zirconia, titania, silicates, tin oxide, cubic boron nitride, garnet, fused alumina zirconia, sol gel particles, and the like, as well as mixtures thereof. Examples of sol gel particles can be found in U.S. Pat. Nos. 4,314,827 (Leitheiser et al.); 4,623,364 (Cottringer et al); 4,744,802 (Schwabel); 4,770,671 (Monroe et al.); and 4,881,951 (Wood et al.). Such particles are typically used as abrasive particles.

As used herein, the term abrasive particle also encompasses single abrasive particles bonded together with a polymer, a ceramic, a metal or a glass to form abrasive agglomerates. The term abrasive agglomerate includes, but is not limited to, abrasive/silicon oxide agglomerates that may or may not have the silicon oxide densified by an annealing step at elevated temperatures. Abrasive agglomerates are further described in U.S. Pat. Nos. 4,311,489 (Kressner); 4,652,275 (Bloecher et al.); 4,799,939 (Bloecher et al.); 5,500,273 (Holmes et al.); 6,645,624 (Adefris et al.); and 7,044,835 (Mujumdar et al.). Alternatively, the abrasive particles may be bonded together by inter-particle attractive forces as describe in U.S. Pat. No. 5,201,916 (Berg, et al.). Preferred abrasive agglomerates include agglomerates having diamond as the abrasive particle and silicon oxide as the bonding component.

### Hydrophobic Nanoparticles

Exemplary hydrophobic nanoparticles can include a variety of materials that are inorganic, organic, or a combination thereof. Inorganic (e.g., metal oxide) nanoparticles are generally hydrophilic in nature. They can be rendered hydrophobic upon being surface-modified with a hydrophobic surface treatment. When the nanoparticle is comprised of an organic material, the nanoparticles are non-vitrifiable and may be sufficiently hydrophobic in the absence of a surface treatment in view of the hydrophobic nature of the organic material.

In this context, non-vitrifiable nanoparticles do not have a glass transition temperature (Tg) and are not capable of forming a glassy material. This is in contrast to the binder particles (which are not nanoparticles) disclosed in US 2010/0266812 (Lugg), wherein the vitrifiable binder particles become a solid either (i) through the curing (such as visible light cure or ultraviolet light cure) of a thermosetting liquid composition or (ii) by the cooling of a thermoplastic material, which can be semi-crystalline or glassy material.

Exemplary organic nanoparticle materials include (e.g., alkylated) buckminsterfullerenes (fullerenes) and (e.g., alkylated) polyamidoamine (PAMAM) dendrimers. Specific examples of fullerenes include C₆₀, C₇₀, C₈₂, and C₈₄. Specific examples of PAMAM dendrimers include those of Generations 2 through 10 (G2 G10), available from Aldrich Chemical Company, Milwaukee, Wis. PAMAM dendrimers are currently commercially available with C₁₂ surface functional groups. The alkyl groups on the organic molecules may be straight or branched and may range from at least C₃ to not greater than C₃₀ and may be any size or range in between C₃ and C₃₀. For example, the ranges may be C₃ to C₂₂; C₃ to C₁₈; C₃ to C₁₂; or C₃ to C₈, and any combination or integer therebetween. The surface-modified organic molecules may be present in a continuous phase of an emulsion at a level of from at least 0.1 percent by weight, such as described in U.S. Pat. No. 7,001,580 (Baran et al.).

Exemplary inorganic nanoparticle materials include, for example, a metal phosphate, metal sulfonate, or metal carbonate (e.g., calcium carbonate, calcium phosphate, hydroxy-apatite); a metal oxide (e.g., zirconia, titania, silica, ceria, alumina, iron oxide, vanadia, zinc oxide, antimony oxide, tin oxide, and alumina-silica); and a metal (e.g., gold, silver, or other precious metals).

In some embodiments, the nanoparticles preferably comprise an inorganic material such as a metal oxide material. In some embodiments, the nanoparticles preferably comprise silica, zirconia, or mixtures thereof.

Various nanoparticles are commercially available. Commercial sources of silica nanoparticles are available from Nalco Co., Naperville, Ill. Nanoparticles can also be made using techniques known in the art. For example, zirconia nanoparticles can be prepared using hydrothermal technology, as described for example in PCT Publication No. WO2009/085926 (Kolb et al.).

In some embodiments, the (e.g., non-surface-modified) nanoparticles may be in the form of a colloidal dispersion. For example, colloidal silica dispersions are available from Nalco Co. under the trade designations “NALCO 1040,” “NALCO 1050,” “NALCO 1060,” “NALCO 2327,” and “NALCO 2329.” Zirconia nanoparticle dispersions are available from Nalco Chemical Co. under the trade designation “NALCO OOSSOO8” and from Buhler AG Uzwil, Switzerland under the trade designation “Buhler zirconia Z-WO.”

The nanoparticles may be fully condensed. Fully condensed nanoparticles (with the exception of amorphous silica) typically have a degree of crystallinity (measured as isolated metal oxide particles) greater than 55%, preferably greater than 60%, and more preferably greater than 70%. For example, the degree of crystallinity can range up to about 86% or greater. The degree of crystallinity can be determined by X-ray diffraction techniques. Condensed crystalline (e.g., zirconia) nanoparticles have a high refractive index whereas amorphous nanoparticles typically have a lower refractive index.

Hydrophilic nanoparticles (e.g., metal oxide nanoparticles) can be rendered hydrophobic upon being surface-modified with a hydrophobic surface treatment. Surface modification involves attaching a surface treatment has a first end that will attach to the nanoparticle surface (covalently, ionically, or through strong physisorption) and a second end that imparts steric stabilization that prevents the particles from agglomerating such as permanently fusing together. The inclusion of surface modification can also improve the compatibility of the particles with other materials. For example, an organic end group such as the organic group of an organosilane can improve the compatibility of the particles with organic matrix material such as polymerizable and thermoplastic resins such as the binder of an abrasive article or powder coating.

Examples of surface treatment agents include alcohols, amines, carboxylic acids, sulfonic acids, phosphonic acids, silanes, and titanates. The surface treatment may optionally comprise fluorine substituents. The preferred type of treatment agent is determined, in part, by the chemical nature of the (e.g., metal oxide) nanoparticle surface. Silanes are preferred for silica and for other siliceous fillers. Silanes and carboxylic acids are preferred for metal oxides such as zirconia. When an organosilane surface treatment is applied to metal oxide nanoparticles, the silane end is generally adsorbed by the nanoparticle. When a carboxylic acid is applied to a zirconia nanoparticle, the acid end is generally adsorbed by the zirconia.

Exemplary silanes include, but are not limited to, an alkyltrialkoxysilane such as n-octyltrimethoxysilane, n-octyltriethoxysilane, isooctyltrimethoxysilane, dodecyltrimethoxysilane, octadecyltrimethoxysilane, propyltrimethoxysilane, and hexyltrimethoxysilane; a methacryloxyalkyltrialkoxysilane or acryloxyalkyltrialkoxysilane such as 3-methacryloxypropyltrimethoxysilane, 3-acryloxypropyltrimethoxysilane, and 3-(methacryloxy)propyltriethoxysilane; amethacryloxyalkylalkyldialkoxysilane or acryloxyalkylalkyldialkoxysilane such as 3-(methacryloxy)propylmethyldimethoxysilane, and 3-(acryloxy)propylmethyldimethoxysilane; a methacryloxyalkyldialkylalkoxysilane or acyrloxyalkyldialkylalkoxysilane such as 3-(methacryloxy)propyldimethylethoxysilane; a mercaptoalkyltrialkoxylsilane such as 3-mercaptopropyltrimethoxysilane; a aryltrialkoxysilane such as styrylethyltrimethoxysilane, phenyltrimethoxysilane, phenyltriethoxysilane, and p-tolyltriethoxysilane; a vinyl silane such as vinylmethyldiacetoxysilane, vinyldimethylethoxysilane, vinylmethyldiethoxysilane, vinyltrimethoxysilane, vinyltriethoxysilane, vinyltriacetoxysilane, vinyltriisopropoxysilane, vinyltrimethoxysilane, vinyltriphenoxysilane, vinyltri-t-butoxysilane, vinyltris(isobutoxy)silane, vinyltriisopropenoxysilane, and vinyltris(2-methoxyethoxy)silane; and combinations thereof.

Carboxylic acid surface modifying agents may comprise the reaction product of phthalic anhydride with an organic compound having a hydroxyl group. Suitable examples include, for example, phthalic acid mono-(2-phenylsulfanyl-ethyl) ester, phthalic acid mono-(2-phenoxy-ethyl) ester, or phthalic acid mono-[2-(2-methoxy-ethoxy)-ethyl]ester. In some examples, the organic compound having a hydroxyl group is a hydroxyl alkyl (meth)acrylate such as hydroxyethyl (meth)acrylate, hydroxypropyl (meth)acrylate, or hydroxylbutyl (meth)acrylate. Examples include, but are not limited to, succinic acid acryloyloxy-ethyl) ester, phthalic acid mono-(2-acryloyloxy-ethyl) ester, and phthalic acid mono-(2-acryloyl-butyl) ester. Still others include mono-(meth)acryloxy polyethylene glycol succinate and the analogous materials made from maleic anhydride, glutaric anhydride, and phthalic anhydride.

In another example, the surface modification agent is the reaction product of polycaprolactone and succinic anhydride such as described in PCT Publication No. WO2010/074862 (Jones et al.).

Various other surface treatments are known in the art, such as described in PCT Publication No. WO2007/019229 (Baran et al.).

The surface treatment may include a blend of two or more hydrophobic surface treatments. For example, the surface treatment may comprise at least one surface treatment having a relatively long substituted or unsubstituted hydrocarbon group. In some embodiments, the surface treatment comprises at least one hydrocarbon group having at least 6 or 8 carbon atoms, such as isooctyltrimethoxy silane, with a second surface treatment that is less hydrophobic, such as methyl trimethoxy silane. The relatively long substituted or unsubstituted hydrocarbon group typically has no greater than about 20 carbons atoms.

The surface treatment may also include a blend of a hydrophobic surface treatment and (e.g., a small concentration of) a hydrophilic surface treatment, provided that the inclusion of such does not detract from the properties contributed by the hydrophobic nanoparticles.

The nanoparticles are typically surface-modified prior to mixing the nanoparticles with the dominant particles. The amount of surface modifier is dependent upon several factors such as nanoparticle size, nanoparticle type, molecular weight of the surface modifier, and modifier type. In general, it is preferred that approximately a monolayer of modifier is attached to the surface of the nanoparticle. The attachment procedure or reaction conditions also depend on the surface modifier used. For silanes, it is preferred to surface treat at elevated temperatures under acidic or basic conditions for about 1-24 hours. Surface treatment agents such as carboxylic acids do not require elevated temperatures or extended time.

The surface modification of the nanoparticles in the colloidal dispersion can be accomplished in a variety of ways. The process involves the mixture of an inorganic dispersion with surface modifying agents. Optionally, a co-solvent can be added at this point, such as for example, 1-methoxy-2-propanol, methanol, ethanol, isopropanol, ethylene glycol, N,N-dimethylacetamide, 1-methyl-2-pyrrolidinone, and mixtures thereof. The co-solvent can enhance the solubility of the surface modifying agents as well as the dispersibility of the surface-modified nanoparticles. The mixture comprising the inorganic sol and surface modifying agents is subsequently reacted at room or an elevated temperature, with or without mixing.

Transfer articles described herein can be used to transfer a layer of particles to a rigid or flexible substrate. One or more binders may be used to adhere the transferred particles to the substrate. Such transfer techniques are well-known to those skilled in the art.

A typical method includes the steps of providing a substrate having opposing first and second surfaces; coating a (first) binder on the first surface of the substrate; providing a transfer article as described herein; positioning the first liner of the transfer article on the (first) binder coated on the first surface of the substrate such that the multi-sized particles are in contact with the (first) binder; removing the first liner from the substrate in a manner that separates at least a portion of the multi-sized particles from the first liner thereby transferring multi-sized particles to the substrate; and curing the (first) binder thereby securing the multi-sized particles to the first surface of the substrate. When a second liner is present on a transfer article, it is removed prior to applying the transfer article to the binder on the substrate, thus leaving particles adhered to the first surface of the first liner. When only one liner is used, the transfer article may be in roll form. Thus, prior to positioning the liner on the binder on the substrate, the transfer articles in unrolled to expose the multi-sized particles.

The (first) binder may be at least partially cured prior to applying the transfer article to the substrate. A second binder may be coated on the first binder after curing the first binder before application of the particles. Pressure may be applied to a second surface of the first liner while it is disposed on the substrate before removing the first liner from the substrate. A second surface of the substrate may be coated with a first binder and a layer of particles may be applied from a second particle transfer article by contacting the particles with the first binder of the second surface. The first liner of the second transfer article may then be removed from the substrate; and the first binder of the second surface may then be cured thereby securing the particles to the second surface of the rigid substrate. Optionally, a second binder may be present on the second surface as described with reference to the first surface of the substrate.

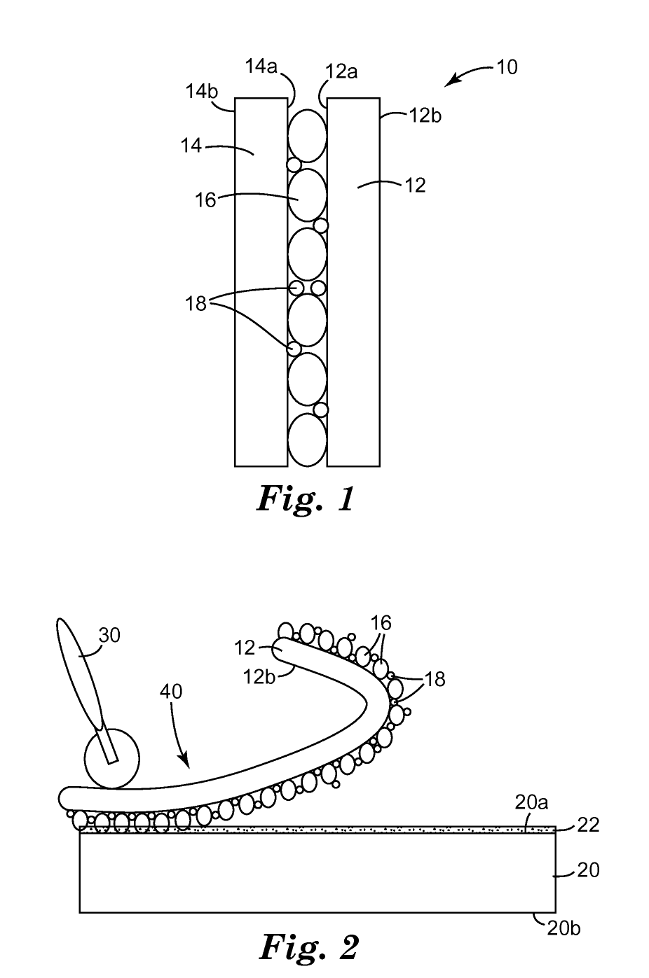

Specifically with reference to the figures, FIG. 2 shows a schematic cross-sectional view of a portion of an exemplary transfer method that can be used to make a coated substrate 40 using a transfer article of the present disclosure. Prior to transferring multi-sized particles, a substrate 20, having opposing first and second surfaces 20a and 20b respectively, has a first binder 22 (sometimes referred to as a “make coat”) coated on first surface 20a. A transfer article, for example, a transfer article of FIG. 1 may be used in the transfer method and, in this case, the second liner 14 of transfer article 10 of FIG. 1 has been removed to expose the multi-sized particles 16/18 which remain on the first liner 12. The first liner 12 is disposed on the rigid substrate such that the multi-sized particles 16/18 are in direct contact with the first binder 22, that is, the multi-sized particles 16/18 are applied to the first binder 22. FIG. 2 shows that pressure is manually applied, using a lamination device 30, to the second surface 12b of the first liner 12 to promote the transfer of the multi-sized particles 16/18 to the first binder 22. Other lamination techniques known to those skilled in the art can also be used. The multi-sized particles 16/18 may

[symbol]

Thereafter the first liner is removed.

During the process of contacting the particles to the first binder, the resinous binder material should be in a tacky state. That is, the first binder should have sufficient tack to enable at least 20%, more preferably at least 50%, and most preferably at least 70% of the particles to be transferred to the first binder. Depending on the type of first binder used, this tacky state can be achieved in a variety of ways.

The thickness of the first binder may be selected based on the size of the multi-sized particles. It is desirable to ensure that as many of the particles as possible are transferred to the first binder. To accomplish this transfer, a thicker binder layer may be used. Multiple transfer articles may be applied to the first binder multiple times to transfer more particles to a given area.

Suitable materials that can function as the rigid substrate include metals, metal alloys, metal-matrix composites, metalized plastics, inorganic glasses and vitrified organic resins, formed ceramics, and polymer matrix reinforced composites. Suitable flexible substrates include, but are not limited to, densified Kraft paper (such as those commercially available from Loparex North America, Willowbrook, Ill.), poly-coated paper such as polyethylene coated Kraft paper, and polymeric film. Suitable polymeric films include polyester, polycarbonate, polypropylene, polyethylene, cellulose, polyamide, polyimide, polysilicone, polytetrafluoroethylene, polyethylenephthathalate, polyvinylchloride, polycarbonate, or combinations thereof. Nonwoven or woven liners may also be useful. The binders may be formed from a solvent-based mixture containing a polymer, oligomer, monomer, or combinations thereof. Alternatively, a binder may be formed from a substantially solvent-free mixture containing a liquid polymer, oligomer, monomer or combinations thereof. Binders may include thermosetting resins, such as a phenolic resin, aminoplast resin having a pendant α,β-unsaturated carbonyl group, urethane resin, acrylated urethane resin, epoxy resin, acrylated epoxy resin, ethylenically-unsaturated resin, acrylated isocyanurate resin, urea-formaldehyde resin, isocyanurate resin, bismaleimide resin, fluorene modified epoxy resin, and mixtures thereof. Optionally, the binder can also contain one or more additives, such as, for example, a filler (including grinding aids), fibers, a lubricant, a wetting agent, a thixotropic material, a surfactant, a pigment, a dye, an antistatic agent, a coupling agent, a plasticizer, and a suspending agent. The amounts of these materials are selected to provide the properties desired.

1. A transfer article comprising:

a first flexible liner having opposing first and second surfaces, wherein the first surface has a release value of less than 700 grams per inch per ASTM D3330/D3330M-04;

multi-sized particles adhered to the first surface of the first flexible liner; the multi-sized particles comprising:
a plurality of dominant hydrophilic particles having an average primary particle size of no greater than 200 microns; and
a plurality of discrete hydrophobic nanoparticles;
wherein the dominant particles are disposed in a monolayer; and

a second flexible liner having opposing first and second surfaces, wherein the second liner is in physical contact with at least a portion of the multi-sized particles.

2. The transfer article of embodiment 1 wherein the first flexible liner and the second flexible liner are portions of the same flexible liner, and the transfer article is in the form of a roll.

3. The transfer article of embodiment 2 wherein the flexible liner comprises a flexible backing and a release coating disposed on the first surface of the liner, the release coating comprising a fluorine-containing material, a silicon-containing material, a fluoropolymer, a silicone polymer or a poly(meth)acrylate ester derived from a monomer comprising an alkyl (meth)acrylate having an alkyl group having 12 to 30 carbon atoms.

4. The transfer article of embodiment 3 further comprising a second release coating disposed on the second surface of the flexible liner, wherein the second release coating has a lower release value than the first release coating.

5. The transfer article of embodiment 1 wherein the first flexible liner is a distinct liner from the second flexible liner, and the first surface of the second flexible liner has a release value of less than 700 grams per inch as measured according to ASTM D3330/D3330M-04, and wherein the second liner is disposed on the layer of particles such that the first surface of the second liner is in contact with the particles.

6. The transfer article of embodiment 5 wherein at least one of the first flexible liner and second flexible liner comprise a flexible backing and a release coating disposed on at least one of the first surface of the first and second liner, the release coating comprising a fluorine-containing material, a silicon-containing material, a fluoropolymer, a silicone polymer or a poly(meth)acrylate ester derived from a monomer comprising an alkyl (meth)acrylate having an alkyl group having 12 to 30 carbon atoms.

7. The transfer article of any one of embodiments 1 through 6 wherein the flexible liner comprises a flexible backing selected from the group consisting of densified Kraft paper, poly-coated paper, and polymeric film.

[symbol]

group consisting of polyester, polycarbonate, polypropylene, polyethylene, cellulose, polyamide, polyimide, polysilicone, polytetrafluoroethylene, polyethylenephthathalate, polyvinylchloride, polycarbonate, and combinations thereof.

9. The transfer article of any one of embodiments 1 through 8 wherein the first surface of the first flexible liner has a smooth, glossy finish.

10. A transfer article comprising:

a first liner having opposing first and second surfaces, wherein the first surface has a release value of less than 700 grams per inch per ASTM D3330/D3330M-04;

multi-sized particles adhered to the first surface of the first liner by electrostatic forces without a binder; the multi-sized particles comprising:
a plurality of dominant hydrophilic particles having an average primary particle size of no greater than 200 microns, and
a plurality of discrete hydrophobic nanoparticles;
wherein the dominant particles are preferably disposed in a monolayer.

11. The transfer article of embodiment 10 wherein the first liner is a flexible liner.

12. The transfer article of embodiment 10 or embodiment 11 further comprising a second liner having opposing first and second surfaces, wherein the second liner is in physical contact with at least a portion of the multi-sized particles.

13. The transfer article of any one of embodiments 1 through 12 wherein the dominant hydrophilic particles have an average primary particle size 100 to 10,000 times larger than the average primary particle size of the nanoparticles.

14. The transfer article of any one of embodiments 1 through 13 wherein the hydrophobic nanoparticles comprise a metal oxide material and a hydrophobic surface treatment.

15. The transfer article of embodiment 14 herein the nanoparticles comprise silica, zirconia, or a mixture thereof.

16. The transfer article of embodiment 14 wherein the hydrophobic surface treatment is an organosilane compound.

17. The transfer article of any one of embodiments 1 through 13 wherein the hydrophobic nanoparticles comprise an organic nonvitrifiable material.

18. The transfer article of any one of embodiments 1 through 17 wherein the dominant hydrophilic particles comprise fused aluminum oxide, heat treated aluminum oxide, white fused aluminum oxide, black silicon carbide, green silicon carbide, titanium diboride, boron carbide, tungsten carbide, titanium carbide, natural diamond, synthetic diamond, silica, iron oxide, chromia, ceria, zirconia, titania, silicates, tin oxide, cubic boron nitride, garnet, fused alumina zirconia, sol gel particles, or a mixture thereof.

[symbol]

particles are disposed on the first liner in a more uniform layer at a higher density than the same hydrophilic particles without the hydrophobic nanoparticles.

20. A method of transferring particles to a substrate, the method comprising:

providing a substrate having opposing first and second surfaces;

coating a binder on the first surface of the substrate;

providing a transfer article of embodiment 10; positioning the first liner on the binder coated on the first surface of the substrate such that the multi-sized particles are in contact with the binder;

removing the first liner from the substrate in a manner that separates at least a portion of the multi-sized particles from the first liner thereby transferring multi-sized particles to the substrate; and

curing the binder thereby securing the transferred multi-sized particles to the first surface of the substrate.

21. A method of transferring particles to a substrate, the method comprising:

providing a substrate having opposing first and second surfaces;

coating a binder on the first surface of the substrate;

providing a transfer article of embodiment 2 in roll form;

unrolling the transfer article to expose the multi-sized particles disposed on the flexible liner;

positioning the flexible liner on the binder coated on the first surface of the substrate such that the multi-sized particles are in contact with the binder;

removing the flexible liner from the substrate in a manner that separates at least a portion of the multi-sized particles from the flexible liner thereby transferring multi-sized particles to the substrate; and

curing the binder thereby securing the transferred multi-sized particles to the first surface of the substrate.

22. A method of transferring particles to a substrate, the method comprising:

providing a substrate having opposing first and second surfaces;

coating a binder on the first surface of the substrate;

providing a transfer article of embodiment 5;

removing the second flexible liner from the transfer article to expose the multi-sized particles disposed on the first flexible liner;

positioning the first flexible liner on the binder coated on the first surface of the substrate such that the multi-sized particles are in contact with the binder;

removing the first flexible liner from the substrate in a manner that separates at least a portion of the multi-sized particles from the first flexible liner thereby transferring multi-sized particles to the substrate; and

curing the binder thereby securing the transferred multi-sized particles to the first surface of the substrate.

Objects and advantages of this disclosure are further illustrated by the following examples, but the particular materials and amounts thereof recited in these examples, as well as other conditions and details, should not be construed to unduly limit this disclosure.

### Method for Preparing Dominant Hydrophilic Retroreflective Particles

Retroreflective elements with complete concentric optical interference layers were formed by depositing metal oxide (titania or silica) coatings onto transparent spherical bead cores using an atmospheric pressure chemical vapor deposition process (APCVD) similar to that described in U.S. Pat. No. 5,673,148 (Morris et al.), the disclosure of which is incorporated herein by reference thereto. The reactor had an internal diameter of 30 millimeters (mm) The initial charge of transparent bead cores weighed 60 grams (g) (the average particle size of the bead cores was 75 microns). For coating silica, the reaction temperature was set at 40° C. while titania coatings a reaction temperature of 140° C. was used. The desired reaction temperature was controlled by immersing the reactor in a heated oil bath maintained at a constant temperature. The bed of spherical beads was fluidized with a stream of nitrogen gas introduced into the reactor through a glass frit reactor base. Once satisfactory fluidization was achieved, water vapor was introduced into the reactor through the base glass frit using a stream of nitrogen carrier gas passed through a water bubbler. The metal oxide precursor compounds (either SiCl₄ or TiCl₄) were vaporized by passing nitrogen carrier gas through a bubbler containing the neat liquid precursor and introducing the vaporized compounds into the reactor through a glass tube extending downward into the fluidized bead bed. Flow rates of the reactant-laden carrier gases and reaction temperatures for silica and titania coatings are reported in Table 1.

TABLE 1

| | | | | Water | Extra |
|---|---|---|---|---|---|
| | Reaction | | Precursor | bubbler | Nitrogen |
| Type of | Temperature | | bubbler flow | flow rate | flow rate |
| coating | (° C.) | Precursor | rate (cc/min) | (cc/min) | (cc/min) |
| SiO₂ | 40 | SiCl₄ | 40 | 600 | 500 |
| TiO₂ | 140 | TiCl₄ | 600 | 600 | 500 |

In some instances, samples of different coating thicknesses were made by varying the coating times. This was accomplished by removing a small volume of retroreflective elements (i.e., particles) from the reactor at different times. Coating rates were determined by fracturing certain concentrically coated glass retroreflective elements that had been sampled from the reactor at known coating deposition times and examining the fracture pieces with a scanning electron microscope to directly measure the coating thicknesses. Thereafter, the thicknesses of the concentric coatings were calculated from known coating times and coating rates. A coating rate of approximately 2 nanometers per minute (nm/min) was [symbol] coatings.

For retroreflective elements having multiple coatings, the additional layers were deposited by repeating the procedure for each additional complete concentric optical interference layer. The coating was on the order of nanometers, so the average particle size of the retroreflective elements was 75 microns.

### Method for Preparing Hydrophobic Surface-Modified Nanoparticles

A sample of 100 g (16.15% solids) of a silica sol (average primary particle size was 5 nm, NALCO 2326, obtained from Nalco Company, Naperville, Ill.) was weighed into a 500-mL round bottom flask equipped with a mechanical stirrer and a reflux condenser. A sample of isooctyltrimethoxysilane (7.58 g) and 0.78 g of methyltrimethoxysilane (both obtained from Gelest, Inc., Morrisville, Pa.) were combined with 40 g of ethanol. This mixture was added to the NALCO 2326 silica sol with stirring. Another 50 g of ethanol was added along with 23 g of methanol. The mixture was heated to 80° C. with stirring overnight. The dispersion was dried in a flow-through oven at 150° C. The resultant hydrophobic nanoparticles were used without further workup or processing. The average primary particle size of the surface-modified nanoparticles was 5 nm.

### Example 1

### Method for Preparing Dominant Hydrophilic Retroreflective Dominant Particles Blended with Hydrophobic Surface-Modified Nanoparticles

A sample of 20.44 g of retroreflective elements prepared as described above was combined with 0.1 g of surface-modified nanoparticles prepared as described above. The blend was mixed on a FlackTek SPEEDMIXER (obtained from FlakTek Inc., Landrum, S.C.) at 3000 revolutions per minute (RPM) for thirty seconds. This was repeated three times with manual shaking between runs. No further processing was done.

### Example 2

### Method for Preparing Hydrophilic Calcium Carbonate Dominant Particles Blended with Hydrophobic Surface-Modified Nanoparticles

A sample of 19.98 g of CaCO₃ (about 10 micrometer average particle size, obtained from Sigma Aldrich Chemical Company, Milwaukee, Wis.) was combined with 0.02 g of the hydrophobic surface-modified nanoparticles prepared as described above. The blend was mixed on a FlackTek SPEEDMIXER (obtained from FlakTek Inc., Landrum, S.C.) at 3000 RPM for sixty seconds. No further processing was done.

[symbol]

### With Hydrophilic Nanoparticles

A sample of 20.00 g of retroreflective elements prepared as described above were combined with 0.62 g of NALCO 2326 colloidal silica sol (16.12% solids, not surface treated to form hydrophobic nanoparticles) and 20 g of deionized water (18M obtained from Millipore Inc., Billerica, Mass.) and 20 g of isopropanol (obtained from EMD Chemicals, Gibbstown, N.J.). The dispersion was mixed using a stilling bar for 2 hours (hrs) and then dried in an oven at 120° C.

### Comparative Example B

### Preparation of Dominant Hydrophilic Retroreflective Elements Blended with Hydrophobic Polyester Resin Particles

Approximately 0.2 g of a polyester powder (GRILTEX D1644 E P1-P3 available from EMS-Chemie North America Inc., Sumter, S.C., sieved to recover particles of <38 microns in size; hydrophobic particles larger than 100 nanometers (i.e., not nanoparticles)) was combined with 20 g of dominant hydrophilic retroreflective elements prepared as described above and rolled in a 200 milliter (mL) plastic jar for 2 hrs.

### Comparative Example C

### Preparation of Dominant Hydrophilic Particles

Dominant hydrophilic retroreflective particles of Comparative Example C were those particles prepared as described above under “Method for preparing dominant hydrophilic retroreflective particles” with no further treatments.

### Electrostatic Coatings

A 46 cm×61 cm×0.3 cm sheet of aluminum was covered with a sheet of unbleached Kraft paper and 46 cm×46 cm sheet of 3M SCOTCHPAK 4935 release liner with the release side facing up. Approximately 5 g of the blend of dominant hydrophilic retroreflective elements and hydrophilic nanoparticles of Comparative Example A, and 5 g of the blend of dominant hydrophilic retroreflective elements and hydrophobic surface-modified nanoparticles of Example 1 were poured in a fine line pile on the above release liner. The aluminum sheet with the liners and particles disposed thereon was held at a 45° angle. The aluminum sheet was tapped gently with a metal rod. This sample was further tilted to 90 degrees, and gently tapped. As a result of the tapping action, excess particles flowed down the release liner surface.

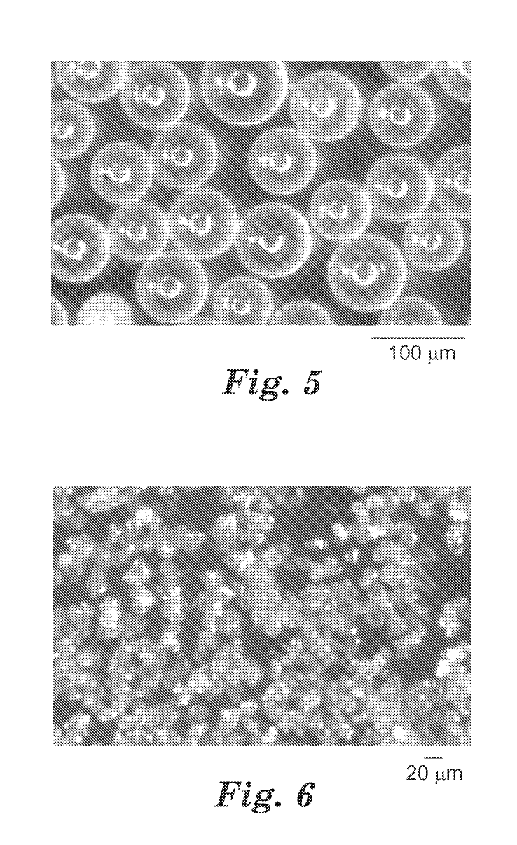

After the tilting and tapping, a close-packed monolayer coating of dominant hydrophilic retroreflective elements of Example 1 remained on the release liner, which were photographed (see FIG. 4 right panel and FIG. 5) and stored for months. The coating weight of the Example 1 blend of dominant hydrophilic retroreflective elements and hydrophobic nanoparticles was 0.5480 g of particles/58 cm². FIG. 4 (right panel) shows a uniform and dense monolayer. FIG. 5 is a microscope photograph (taken in a horizontal position although it was prepared and stored in a vertical position) that shows the close-packed orientation of the particles in the monolayer.

[symbol]

retroreflective elements and hydrophilic nanoparticles of Comparative Example A. After the tilting and tapping, a discontinuous layer of the blend of dominant hydrophilic retroreflective elements and hydrophilic nanoparticles of Comparative Example A partially remained on the release liner.

The same procedure as above was repeated using the blend of dominant hydrophilic retroreflective elements and hydrophobic particles larger than 100 nanometers (i.e., not nanoparticles) of Comparative Example B. After the tilting and tapping, the Comparative Example B retroreflective elements fell off leaving behind a trail of powdery resin particles of varying sizes on the release liner surface.

The same procedure was repeated using the dominant hydrophilic retroreflective elements (alone) of Comparative Example C. After the tilting and tapping, a discontinuous layer of the dominant hydrophilic retroreflective elements of Comparative C partially remained on the release liner (see the left panel of FIG. 4).

The same procedure as above was repeated with the blend of dominant hydrophilic retroreflective elements and hydrophobic nanoparticles of Example 2 as well as with as-received CaCO₃ powders (without blending with the hydrophilic surface-treated nanoparticles). The dominant hydrophilic particles (calcium carbonate particles) blended with surface-modified nanoparticles of Example 2 provided a more uniform and complete coating on the surface of the release liner than did the calcium carbonate particles alone.

FIG. 6 is a photograph of a transfer article with a blend of the dominant hydrophilic calcium carbonate particles and hydrophobic nanoparticles (not of sufficient magnification to be seen) of Example 2 held electrostatically onto a release liner under humid conditions. This sample was photographed in a horizontal position although it was prepared in a vertical position. This shows the close-packed orientation of the particles.

As shown by these examples, the dominant hydrophilic particles form a more uniform and higher density layer when used in combination with discrete hydrophobic nanoparticles relative to the same dominant hydrophilic particles without the hydrophobic nanoparticles, and relative to the same dominant hydrophilic particles with hydrophobic particles larger than 100 nanometers.

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A transfer article comprising:
a first flexible liner having opposing first and second surfaces, wherein the first surface has a release value of less than 700 grams per inch per ASTM D3330/D3330M-04;
multi-sized particles adhered to the first surface of the first flexible liner; the multi-sized particles comprising:
a plurality of dominant hydrophilic particles having an average primary particle size of no greater than 200 microns; and
a plurality of discrete hydrophobic nanoparticles;
wherein the dominant particles are disposed in a monolayer; and
a second flexible liner having opposing first and second surfaces, wherein the second liner is in physical contact with at least a portion of the multi-sized particles.

2. The transfer article of claim 1 wherein the first flexible liner and the second flexible liner are portions of the same flexible liner, and the transfer article is in the form of a roll.

3. The transfer article of claim 2 wherein the flexible liner comprises a flexible backing and a release coating disposed on the first surface of the liner, the release coating comprising a fluorine-containing material, a silicon-containing material, a fluoropolymer, a silicone polymer or a poly(meth)acrylate ester derived from a monomer comprising an alkyl (meth)acrylate having an alkyl group having 12 to 30 carbon atoms.

4. The transfer article of claim 3 further comprising a second release coating disposed on the second surface of the flexible liner, wherein the second release coating has a lower release value than the first release coating.

5. The transfer article of claim 1 wherein the first flexible liner is a distinct liner from the second flexible liner, and the first surface of the second flexible liner has a release value of less than 700 grams per inch as measured according to ASTM D3330/D3330M-04, and wherein the second flexible liner is disposed on the layer of particles such that the first surface of the second flexible liner is in contact with the particles.

6. The transfer article of claim 5 wherein at least one of the first flexible liner and second flexible liner comprise a flexible backing and a release coating disposed on at least one of the first surface of the first and second liner, the release coating comprising a fluorine-containing material, a silicon-containing material, a fluoropolymer, a silicone polymer or a poly(meth)acrylate ester derived from a monomer comprising an alkyl (meth)acrylate having an alkyl group having 12 to 30 carbon atoms.

7. The transfer article of claim 6 wherein the flexible backing selected from the group consisting of densified Kraft paper, poly-coated paper, and polymeric film.

8. The transfer article of claim 7 wherein the polymeric film is selected from the group consisting of polyester, polycarbonate, polypropylene, polyethylene, cellulose, polyamide, polyimide, polysilicone, polytetrafluoroethylene, polyethylenephthathalate, polyvinylchloride, polycarbonate, and combinations thereof.

9. The transfer article of claim 1 wherein the first surface of the first flexible liner has a smooth, glossy finish.

10. A transfer article comprising:
a first liner having opposing first and second surfaces, wherein the first surface has a release value of less than 700 grams per inch per ASTM D3330/D3330M-04;
multi-sized particles adhered to the first surface of the first liner by electrostatic forces without a binder; the multi-sized particles comprising:
a plurality of dominant hydrophilic particles having an average primary particle size of no greater than 200 microns, and
a plurality of discrete hydrophobic nanoparticles.

11. The transfer article of claim 10 wherein the first liner is a flexible liner.

12. The transfer article of claim 11 further comprising a second liner having opposing first and second surfaces, wherein the second liner is in physical contact with at least a portion of the multi-sized particles.

13. The transfer article of claim 10 wherein the dominant hydrophilic particles have an average primary particle size 100 to 10,000 times larger than the average primary particle size of the nanoparticles.

14. The transfer article of claim 10 wherein the hydrophobic nanoparticles comprise a metal oxide material and a hydrophobic surface treatment.

15. The transfer article of claim 14 herein the nanoparticles comprise silica, zirconia, or a mixture thereof.

16. The transfer article of claim 14 wherein the hydrophobic surface treatment is an organosilane compound.

17. The transfer article of claim 10 wherein the hydrophobic nanoparticles comprise an organic nonvitrifiable material.

18. The transfer article of claim 10 wherein the dominant hydrophilic particles comprise fused aluminum oxide, heat treated aluminum oxide, white fused aluminum oxide, black silicon carbide, green silicon carbide, titanium diboride, boron carbide, tungsten carbide, titanium carbide, natural diamond, synthetic diamond, silica, iron oxide, chromia, ceria, zirconia, titania, silicates, tin oxide, cubic boron nitride, garnet, fused alumina zirconia, sol gel particles, or a mixture thereof.

19. The transfer article of claim 10 wherein the multi-sized particles are disposed on the first liner in a more uniform layer at a higher density than the same hydrophilic particles without the hydrophobic nanoparticles.
